(19) United States
(12) Patent Application Publication
(10) Pub. No.: US 2025/0382412 A1
(43) Pub. Date: Dec. 18, 2025

(54) PROCESS FOR THE SYNTHESIS OF POLY-4-HYDROXYBUTYRATE

(71) Applicant: BASF SE, Ludwigshafen am Rhein (DE)

(72) Inventors: Thomas SCHAUB, Ludwigshafen am Rhein (DE); Bernd BRUCHMANN, Freinsheim (DE); Dieter RODEWALD, Ludwigshafen am Rhein (DE); Mathieu NICOLAS, Lyon (FR); Alban FALCONNET, Heidelberg (DE)

(21) Appl. No.: 18/878,714

(22) PCT Filed: Jun. 29, 2023
(86) PCT No.: PCT/EP2023/067811

§ 371 Date: Dec. 24, 2024

(30) Foreign Application Priority Data
Jun. 29, 2022 (EP) 22181950.1

(51) Int. Cl. C08G 63/08; C08G 63/81

(52) U.S. Cl. CPC C08G 63/08; C08G 63/81

(57) ABSTRACT

Described are a process for the synthesis of poly-4-hydroxybutyrate, the use of a kit comprising (i) one or more bases comprising an alkaline metal cation and (ii) one or more alcohols in said process and to poly-4-hydroxybutyrate obtainable by said process.

The present application relates to a process for the synthesis of poly-4-hydroxybutyrate, the use of a kit comprising (i) one or more bases comprising an alkaline metal cation and (ii) one or more alcohols in said process, and to poly-4-hydroxybutyrate obtainable by said process.

Poly-4-hydroxybutyrates are an important class of aliphatic polyesters. Poly-4-hydroxybutyrate is a biocompatible and biodegradable thermoplastic material, and therefore it is currently of high interest to replace other common plastics, which are not or which are hardly biodegradable.

Currently, commercial poly-4-hydroxybutyrate is usually produced by biological fermentation using sugars as feedstock. However, these processes have certain drawbacks, e.g. inefficient use of the starting material due to the metabolisms of the microorganisms, relatively complex processes, low space-time-yield; and it is difficult to isolate and purify the product from the fermentation mixture.

Poly-4-hydroxybutyrate could also be synthesized by catalytic ring-opening polymerization reaction of γ-butyrolactone. The educt γ-butyrolactone is a cheap, easily available material which can be obtained from biomass feedstock. This provides access to a polymer which is not only biodegradable but also obtainable from renewable resources. However, traditionally, γ-butyrolactone was considered as non-polymerizable due to the low strain energy of the five membered ring compared to other easy to polymerize lactones as e.g. caprolactone (see: Q. Song et al., Polymer Journal, 2020, 52, 3-11). Certain progress was made in the last years due to the development of catalyst systems which are capable of polymerizing γ-butyrolactone to poly-4-hydroxybutyrate. However, usually low reaction temperatures below −30° C. are required, the catalysts are rather elaborated, the obtained yields are only moderate and the reaction is to be carried out in a relatively diluted solution which is unfavorable from an economic perspective.

CN 102643301A discloses the use of pentacoordinated aluminum complexes bearing an alkoxide ligand for the polymerization of γ-butyrolactone to poly-4-hydroxybutyrate at temperatures of 25° C. to 108° C. in an organic solvent. Despite that high yields of up to 95% of the poly-4-hydroxybutyrate may be obtained by this process, the reaction mixture to be used is rather diluted with only 1 g γ-butyrolactone dissolved in 21 mL toluene, which makes the work-up costly, as all toluene must be removed in vacuo before further isolating the polymeric product. Another drawback is the multi-step synthesis of the elaborated aluminum catalyst starting from expensive and notoriously difficult to handle highly pyrophoric AlMe₃.

Macromolecules, 2018, 51, 9317-9322, describes the polymerization of γ-butyrolactone to poly-4-hydroxybutyrate using specific urea-derivatives in combination with alkali-alcoholates as initiators without a solvent. A conversion rate of γ-butyrolactone of 86% was obtained at a reaction temperature of −40° C. at a γ-butyrolactone:Phenyl-Cyclohexyl-Urea:NaOMe ratio of 300:3:1. When increasing the reaction temperature to −20° C. the yield drops to 70% at a ratio γ-butyrolactone:Phenyl-Cyclohexyl-Urea:NaOMe of 100:1:1 which is unfavorable from an economic point of view.

CN 109851765 discloses the polymerization of γ-butyrolactone to poly-4-hydroxybutyrate in the presence of specific N-heterocyclic olefins in combination with thiourea derivatives and alcohol in an organic solvent. Yields are not reported. The required temperature of −40° C. and the dedicated synthesis of specific N-heterocyclic olefines as well as of specific thiourea derivatives make this synthesis unfavorable from an economic point of view.

Polymer Chemistry, 2022, 13, 439-445, describes the polymerization of γ-butyrolactone to poly-4-hydroxybutyrate in the presence of benzylic alcohols in combination with dialkyl magnesium compounds and an additional solvent. The highest conversion of γ-butyrolactone of 72% could be obtained at a reaction temperature of −50° C. at a γ-butyrolactone:Ph₂CHOH:MgBu₂ ratio of 50:1:1 in a relatively diluted solution of 8 mol/L in toluene. As the reaction must be carried out at −50° C. and the reaction mixture is relatively diluted, and relatively high amounts of initiator are necessary for sufficient yields, this synthesis is unfavorable from an economic point of view.

Nature Chemistry, 2016, 8, 42-49 describes the polymerization of γ-butyrolactone to poly-4-hydroxybutyrate in the presence of benzylic alcohols in combination with La[N(SiMes)₂]₃. The highest polymer yield of 67% was achieved with Ph₂CHOH (benzylic alcohol) as initiator at a reaction temperature of −40° C. and a γ-butyrolactone:PhCH₂OH:La[N(SiMes)₂]₃ ratio of 100:2:1 in a THF solution by first mixing γ-butyrolactone and benzylic alcohol and then adding La[N(SiMes)₂]₃ at the given reaction temperature. Increasing the reaction temperature to −28° C. results in a drop of the yield to only 16%. When changing—under otherwise identical conditions at −40° C. —the procedure in a way, that first the γ-butyrolactone and benzylic alcohol are dissolved in THF, cooled down and then La[N(SiMes)₂]₃ is added, the polymer yield is decreased to only 33%. This paper also discloses the use of a dedicated lanthanide-catalyst with a tailor-made multidentate phenolate ligand. Using this catalyst, the reaction is carried out without a benzylic alcohol. The highest polymer yield of 90% by using this catalyst was achieved at a reaction temperature of −40° C. at a γ-butyrolactone:La-catalyst ratio of 100:1 in a 10M THF solution by first dissolving the catalyst in THF then adding γ-butyrolactone at the given reaction temperature. But when decreasing the catalyst loading to a γ-butyrolactone:La-catalyst ratio of 200:1, the polymer yield drops to 48%. Using the diol COH₄(CH₂OH)₂ in combination with the lanthanide catalyst at a ratio of 100:1:1.5, the highest polymer yield was only 33% at −40° C. As the reaction must be carried out at −40° C. for acceptable yields, it is unfavorable from an economic point of view. Additionally, the Lanthanide-compounds are relatively expensive and sensitive and a catalyst loading of at least 1 mol % is needed for acceptable yields, which is also not beneficial from an economic point of view.

Angewandte Chemie International Edition, 2016, 55, 4188-4193, describes the ring-opening polymerization of γ-butyrolactone to poly-4-hydroxybutyrate in the presence of a benzylic alcohol either in combination with a phosphazene base or with a strong alkaline base. The highest polymer yield of 90% with the phosphazene base was achieved at a reaction temperature of −40° C. at a γ-butyrolactone:PhCH₂OH:phosphazene ratio of 100:1.5:1 in a diluted solution of 10 mol/L in THF by first mixing γ-butyrolactone and benzylic alcohol and then adding the base at the given reaction temperature. When the reaction temperature is increased to −28° C., the polymer yield massively drops to only 20%. When replacing the phosphazene base by the simpler and cheaper base NaOMe under otherwise identical conditions, the yield drops to 72.8% at a reaction temperature of −40° C. Since the reaction must be carried out at −40° C. for acceptable yields, the reaction mixture is relatively diluted, a sensitive and expensive phosphazene base is needed as catalyst, and relatively high amounts of initiator are necessary for sufficient yields, this synthesis is unfavorable from an economic point of view.

Related prior art is

Song Qilei et al.: “Ring-opening polymerization of [gamma]-lactones and copolymerization with other cyclic monomers”, Progress in Polymer Science, Pergamon Press, Oxford, GB, vol. 110, available online 18 Sep. 2020 (2020-09-18).

It was a primary object of this invention to provide a process for the synthesis of poly-4-hydroxybutyrate by ring-opening polymerization of γ-butyrolactone which can be performed using a simple, easily accessible, and cheap catalyst, wherein the process provides the polymer in high yields. It was a further object to provide a process for ring-opening polymerization of γ-butyrolactone which does not require temperatures below −25° C., so that less energy is needed for cooling.

The primary object and other objects of the present invention are accomplished by a process for the synthesis of poly-4-hydroxybutyrate, said process comprising the steps of
(a) preparing a reaction mixture comprising
   (i) one or more bases comprising an alkali metal cation
   (ii) one or more alcohols
   and

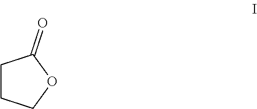

(iii) γ-butyrolactone (I)
wherein in the reaction mixture the molar ratio of γ-butyrolactone (iii) to the total amount of (i) bases comprising an alkali metal cation is 200:1 or higher,
wherein preparing the reaction mixture comprises
(a1) forming a premix comprising
   (i) one or more bases comprising an alkali metal cation
   and
   (ii) one or more alcohols
(a2) providing (iii) γ-butyrolactone having a temperature of −25° C. or more
(a3) obtaining the reaction mixture by charging the premix formed in step (a1) into the γ-butyrolactone having a temperature of −25° C. or higher provided in step (a2),
(b) chemically converting the γ-butyrolactone in said reaction mixture by ring opening-polymerization to poly-4-hydroxybutyrate at a temperature of −25° C. or higher.

Surprisingly it has been found that the order of combining
(i) the one or more bases comprising an alkali metal cation
(ii) the one or more alcohols
and
(iii) γ-butyrolactone
in step (a) has a significant influence on the yield of the ring-opening polymerization, and any deviation from the process defined by sub-steps (a1) through (a3) results in a significant reduction of the yield under otherwise identical conditions.

Therefore, it is crucial that in step (a) the reaction mixture (as defined above) for the ring-opening polymerization of (iii) γ-butyrolactone is prepared by carrying out the above-defined sub-steps (a1) through (a3) in the above-defined order.

In sub-step (a1), a premix is formed comprising or consisting of
(i) one or more bases comprising an alkali metal cation
and
(ii) one or more alcohols.

The base (i) is base comprising an alkali metal cation. The anion of the base (i) may be a proton acceptor (Brønsted base) and/or an electron pair donator (Lewis base). Preferably, the alkali metal cation is selected from the group consisting of Li⁺, Na⁺, K⁺, Rb⁺ and Cs⁺, most preferably from the group consisting of Li⁺, Na⁺ and K⁺.

Without wishing to be bound by any theory, it is presently assumed that the base (i) acts as a catalyst for the ring-opening polymerization of γ-butyrolactone, and the alcohol (ii) acts as an initiator for the ring opening polymerization of γ-butyrolactone.

Usually, in step (a1) the premix is formed by
(a1.1) providing one or more bases (i) comprising an alkali metal cation
(a.1.2) providing one or more alcohols (ii)
(a.1.3) mixing the one or more bases (i) comprising an alkali metal cation provided in sub-step (a.1.1) with the one or more alcohols (ii) provided in sub-step (a.1.2) so that said premix results.

In sub-step (a2), (iii) γ-butyrolactone having a temperature of −25° C. or more, preferably a temperature in the range of from −25° C. to −10° C. is provided. In step (a2), providing γ-butyrolactone can be done continuously or discontinuously.

In sub-step (a3), the reaction mixture for the ring-opening polymerization is obtained by charging the premix formed in step (a1) into the γ-butyrolactone having a temperature of −25° C. or higher provided in step (a2).

In the reaction mixture prepared in step (a), the molar ratio of γ-butyrolactone (iii) to the total amount of (i) bases comprising an alkali metal cation is 200:1 or higher, preferably 200:1 to 800:1 and most preferred 200:1 to 400:1. Thus, the amount of base (i) as catalyst for the ring-opening polymerization of a given amount of γ-butyrolactone is rather low, compared to the prior art processes mentioned above, which is favorable from an economic point of view.

In step (b), γ-butyrolactone is chemically converted by ring opening-polymerization to poly-4-hydroxybutyrate in said reaction mixture prepared in step (a) at a temperature of −25° C. or higher, preferably at a temperature in the range of from −25° C. to +50° C., preferably −25° C. to +30° C., more preferably −25° C. to 0° C., and most preferably at a temperature in the range of from −25° C. to −10° C.

Thus, in the process disclosed herein, the ring-opening polymerization of γ-butyrolactone is carried out at higher temperatures than in the prior art processes (see e.g. Angewandte Chemie International Edition, 2016, 55, 4188-4193). Thus, advantageously, less cooling is necessary, resulting in energy savings.

In step (b), chemically converting γ-butyrolactone by ring opening-polymerization to poly-4-hydroxybutyrate is typically carried out at ambient pressure.

In the premix prepared in step (a1), preferably the base (i) comprising an alkali metal cation or one or more of the bases (i) comprising an alkali metal cation are selected from the group consisting of lithium alkoxides, sodium alkoxides and potassium alkoxides, preferably from the group consisting of lithium methoxide, sodium methoxide, potassium methoxide, lithium tertbutoxide, sodium tertbutoxide, potassium tertbutoxide, lithium benzylalcoholate, sodium benzylalcoholate and potassium benzylalcoholate.

More preferably, in the premix prepared in step (a1), each base (i) comprising an alkali metal cation is selected from the group consisting of lithium alkoxides, sodium alkoxides and potassium alkoxides, preferably from the group consisting of lithium methoxide, sodium methoxide, potassium methoxide, lithium tertbutoxide, sodium tertbutoxide, potassium tertbutoxide, lithium benzylalcoholate, sodium benzylalcoholate and potassium benzylalcoholate.

The most preferred bases (i) are lithium tertbutoxide, sodium tertbutoxide, potassium tertbutoxide and potassium benzylalcoholate.

In the premix prepared in step (a1), preferably the alcohol (ii) or one or more of the alcohols (ii) are selected from the group consisting of
methanol, ethanol, ethyleneglycol, diethyleneglycol, polyethyleneglycol, 1,2-propanediol, dipropyleneglycol, polypropyleneglycol, 1,3-propanediol, 1,4-butanediol, polytetra-methyleneglycol, 1,5-pentanediol, 1,6-hexanediol
and
benzylic alcohols according to formula (II)

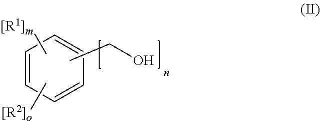

wherein
n is an integer from 1 to 4, preferably 1 or 2
m is an integer from 0 to 3,
is 0 or 1

$$m + n + o \leq 6 ;$$

R¹ and R² are independently of one another selected from the group consisting of F, Cl, Br, OH, CN, NH₂, NO₂,
C₁-C₁₀-alkyl
C₃-C₁₀-cycloalkyl,
C₃-C₁₀-heterocyclyl comprising at least one heteroatom selected from N, O and S,
C₅-C₁₄-aryl,
C₅-C₁₀-heteroaryl comprising at least one heteroatom selected from N, O and S,
wherein said C₁-C₁₀-alkyl, C₃-C₁₀-cycloalkyl, C₃-C₁₀-heterocyclyl, C₅-C₁₄-aryl, resp. C₅-C₁₀-heteroaryl optionally has one or more further substituents selected from the group consisting of F, Cl, Br, OH, CN, NH₂ and C₁-C₁₀-alkyl.

As used herein, C₁-C₁₀-alkyl is intended to include linear C₁-C₁₀-alkyl as well as branched C₄-C₁₀-alkyl alkyls, and n-C₁-C₁₀-alkyl, sec-C₃-C₁₀-alkyl as well as tert-C₄-C₁₀-alkyl.

More preferably, in the premix prepared in step (a1), each alcohol (ii) is selected from the above-defined group.

Among benzylic alcohols according to formula (II), 1,4-benzenedimethanol, 2,6-dichlorobenzylalcohol, 4-methylbenzylalcohol and 2,4,6-trimethyl-benzylalcohol are preferred.

The most preferred alcohols (ii) are methanol, ethanol, polyethyleneglycol, 1,4-butanediol, 1,6-hexanediol, benzylic alcohol, 1,4-benzenedimethanol, 2,6-dichlorobenzylalcohol, 4-methylbenzylalcohol and 2,4,6-trimethylbenzylalcohol.

In the premix prepared in step (a1), most preferably the base (i) comprising an alkali metal cation or one or more of the bases (i) comprising an alkali metal cation are selected from the above-defined group of preferred bases (i), and the alcohol (ii) or one or more of the alcohols (ii) are selected from the above-defined group of preferred alcohols (ii). More preferably, in the premix prepared in step (a1), each base (i) comprising an alkali metal cation is selected from the above-defined group of preferred bases (i), and each alcohol (ii) is selected from the above-defined group of preferred alcohols (ii).

In a specifically preferred process,
(i) said base comprising an alkali metal cation is an alkali metal alkoxide of the formula MOR³ wherein M is selected from the group consisting of Li, Na and K
(ii) said alcohol is an alcohol of the formula R³OH
wherein R³ of (i) is identical to R³ of (ii) and is preferably selected from the group consisting of methyl, ethyl, isopropyl, sec-butyl, tert-butyl and benzyl.

In the reaction mixture prepared in step (a), the molar ratio
of the total amount of (i) bases comprising an alkali metal cation to the total amount of (ii) alcohols is preferably in the range of from 1:1 to 10:1, more preferably from 1:1 to 8:1, most preferably of from 1:1 to 5:1.

In certain cases, it is preferred that the reaction mixture prepared in step (a) further comprises one or more solvents (beside the above-mentioned constituents (i), (ii) and (iii)). In certain cases, the reaction mixture prepared in step (a) consists of
(i) one or more bases comprising an alkali metal cation
(ii) one or more alcohols

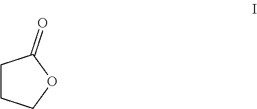

(iii) γ-butyrolactone (I)
and one or more solvents.

Suitable solvents are those in which constituents (i) through (iii) as well as the product poly-4-hydroxybutyrate are soluble resp. with which they are mixable. The presence of one or more solvents in the reaction mixture enables homogeneous distribution of the reactants (i), (ii) and (iii) as defined above and facilitates their interaction.

In the reaction mixture prepared in step (a), preferably the solvent or one or more of the solvents are selected from the group consisting of aliphatic hydrocarbons, aromatic hydrocarbons, ethers, esters, N,N-dialkylamides, dialkylsulfoxides and nitriles.

More preferably, in the reaction mixture prepared in step (a), each solvent is selected from the group consisting of aliphatic hydrocarbons, aromatic hydrocarbons, ethers, esters, N,N-dialkylamides, dialkylsulfoxides and nitriles.

As used herein, the term “hydrocarbons” is intended to include halogenated hydrocarbons.

Further preferably, in the reaction mixture prepared in step (a), the solvent or one or more of the solvents are selected from the group consisting of dichloromethane, toluene, 2-methyl-tetrahydrofurane, 1,4-dioxane, glyme, diglyme, ethyl acetate, dimethylformamide, dimethylsulfoxide and acetonitrile.

Most preferably, in the reaction mixture prepared in step (a), each solvent is selected from the group consisting of dichloromethane, toluene, 2-methyl-tetrahydrofurane, 1,4-dioxane, glyme, diglyme, ethyl acetate, dimethylformamide, dimethylsulfoxide and acetonitrile.

For preparing the reaction mixture in step (a)
a premix comprising (i) one or more bases comprising an alkali metal cation and (ii) one or more alcohols and one or more solvents
and/or
a mixture comprising (iii) γ-butyrolactone (I) and one or more solvents
may be provided.

The solvent or one or more of the solvents are preferably selected from the group consisting of aliphatic hydrocarbons, aromatic hydrocarbons, ethers, esters, N,N-dialkylamides, dialkylsulfoxides and nitriles, most preferably from the group consisting of dichloromethane, toluene, 2-methyl-tetrahydrofurane, 1,4-dioxane, glyme, diglyme, ethyl acetate, dimethylformamide, dimethylsulfoxide and acetonitrile.

More preferably, each solvent is selected from the group consisting of aliphatic hydrocarbons, aromatic hydrocarbons, ethers, esters, N,N-dialkylamides, dialkylsulfoxides and nitriles, most preferably from the group consisting of dichloromethane, toluene, 2-methyl-tetrahydrofurane, 1,4-dioxane, glyme, diglyme, ethyl acetate and acetonitrile.

In certain cases, for preparing the reaction mixture in step (a) a premix in the form of a solution comprising (i) one or more bases comprising an alkali metal cation and (ii) one or more alcohols and one or more solvents may be provided in sub-step (a1).

Preferably, in the premix formed in sub-step (a1), the solvent or one or more of the solvents are selected from the group consisting of aliphatic hydrocarbons, aromatic hydrocarbons, ethers, esters, N,N-dialkylamides, dialkylsulfoxides and nitriles.

More preferably, in the premix prepared in step (a1), each solvent is selected from the group consisting of aliphatic hydrocarbons, aromatic hydrocarbons, ethers, esters, N,N-dialkylamides, dialkylsulfoxides and nitriles.

Further preferably, in the premix formed in sub-step (a1), the solvent or one or more of the solvents are selected from the group consisting of dichloromethane, toluene, 2-methyl-tetrahydrofurane, 1,4-dioxane, glyme, diglyme, ethyl acetate, dimethytformamide, dimethylsulfoxide and acetonitrile.

Most preferably, in the premix prepared in step (a1), each solvent is selected from the group consisting of dichloromethane, toluene, 2-methyl-tetrahydrofurane, 1,4-dioxane, glyme, diglyme, ethyl acetate, dimethylformamide, dimethylsulfoxide and acetonitrile.

In certain cases, for preparing the reaction mixture in step (a) a mixture comprising (ii) γ-butyrolactone (I) and one or more solvents may be provided in sub-step (a2).

Preferably, in the mixture provided in sub-step (a2) the solvent or one or more of the solvents are selected from the group consisting of aliphatic hydrocarbons, aromatic hydrocarbons, ethers, esters, N,N-dialkylamides, dialkylsulfoxides and nitriles.

More preferably, in the mixture provided in sub-step (a2), each solvent is selected from the group consisting of aliphatic hydrocarbons, aromatic hydrocarbons, ethers, esters, N,N-dialkylamides, dialkylsulfoxides and nitriles.

Further preferably, in the mixture provided in sub-step (a2), the solvent or one or more of the solvents are selected from the group consisting of dichloromethane, toluene, 2-methyl-tetrahydrofurane, 1,4-dioxane, glyme, diglyme, ethyl acetate, dimethylformamide, dimethylsulfoxide and acetonitrile.

Most preferably, in the mixture provided in sub-step (a2), each solvent is selected from the group consisting of dichloro-methane, toluene, 2-methyl-tetrahydrofurane, 1,4-dioxane, glyme, diglyme, ethyl acetate, dimethylformamide, dimethylsulfoxide and acetonitrile.

In more specific cases, for preparing the reaction mixture in step (a)
a premix comprising (i) one or more bases comprising an alkali metal cation and (ii) one or more alcohols and one or more solvents
and/or
a mixture comprising (iii) γ-butyrolactone (I) and one or more solvents
is provided.

The solvent or one or more of the solvents are preferably selected from the group consisting of aliphatic hydrocarbons, aromatic hydrocarbons, ethers, esters, N,N-dialkylamides, dialkylsulfoxides, and nitriles, most preferably from the group consisting of dichloromethane, toluene, 2-methyl-tetrahydrofurane, 1,4-dioxane, glyme, diglyme, ethyl acetate, dimethylformamide, dimethylsulfoxide and acetonitrile.

More preferably, each solvent is selected from the group consisting of aliphatic hydrocarbons, aromatic hydrocarbons, ethers, esters, N,N-dialkylamides, dialkylsulfoxides and nitriles, most preferably from the group consisting of dichloromethane, toluene, 2-methyl-tetrahydrofurane, 1,4-dioxane, glyme, diglyme, ethyl acetate, dimethylformamide, dimethylsulfoxide and acetonitrile.

In certain cases, the above-defined process further comprises drying of the γ-butyrolactone (I) by adding a drying agent, and optional separation of the dried γ-butyrolactone (I) from the drying agent before preparing the reaction mixture. Drying can be achieved by means of any suitable drying agent.

The drying agent is preferably selected from the group consisting of selected from the group consisting of
CaH₂,
tosyl isocyanate,
and oxazolidines.

The oxazolidine is preferably selected from the group consisting of oxazolidines of formula (III), oxazolidines of formula (IV), and oxazolidines of formula (V)

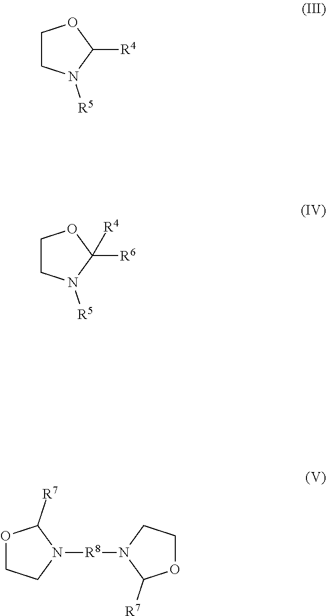

wherein
R⁴, R⁵, R⁶, and R⁷ are independently of one another selected from the group consisting of H— and C₁-C₁₀-alkyl
and R⁸ is a bridging unit comprising 1 to 20 —CH₂-units (methylene units) and optionally one or more moieties selected from the group consisting of
—NH—,
—O— (ether bridge),
—CO-(carbony)
—COO— (carboxyl)
and —NH—COO— (urethane).

As used herein, C₁-C₁₀-alkyl is intended to include linear C₁-C₁₀-alkyl as well as branched C₄-C₁₀-alkyl alkyls, and n-C₁-C₁₀-alkyl, sec-C₃-C₁₀-alkyl as well as tert-C₄-C₁₀-alkyl.

In certain preferred oxazolidines of formula (V), the bridging unit R⁸ is

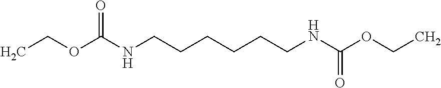 [SMILES: CCOC(=O)NCCCCCCNC(=O)OCC]

In certain preferred oxazolidines of formula (II) and (IV), resp., R⁴ is selected from branched alkyl e. g. sec-C₃-C₁₀-alkyl or tert-C₄-C₁₀, R⁵ is selected from n-C₁-C₁₀-alkyl and R⁶ in formula (IV) is methyl.

Most preferably, the oxazolidine is of formula (VI)

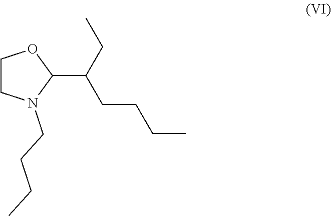 [SMILES: CCCCC(CC)C1OCCN1CCCC]

The oxazolidine of formula (VI) is sold under the trade name “INCOZOL 2” by the company Incorez.

The above-mentioned substances are capable of acting as a drying agent for γ-butyrolactone.

Before preparing the reaction mixture, the dried γ-butyrolactone (I) may be separated from the drying agent by distillation, in order to avoid the presence of the drying agent resp. its reaction products with water in the target product poly-4-hydroxybutyrate. Especially when CaH₂ is used as the drying agent, it is preferable to separate the dried γ-butyrolactone (I) from the used-up CaH₂ by means of distillation. Irrespective of the drying agent applied, distillation has to be carried out under protecting atmosphere (e.g. nitrogen or argon), in order to prevent the dried γ-butyrolactone (I) from taking up of air moisture.

Preferably, the γ-butyrolactone provided in step (a2) has a water content of 0.1 wt % or lower, preferably 0.05% or lower, and most preferably 0.01% or lower, as measured at 20° C. by Karl-Fischer-titration. Said low water content may be achieved by applying a drying agent, preferably one of the above-mentioned preferred drying agents.

In certain cases, it is preferred that the above defined process for the synthesis of poly-4-hydroxybutyrate further comprises the step of
(c) quenching the ring-opening polymerization by adding a quenching solution comprising one or more acids and one or more solvents to the reaction mixture.

By means of quenching, the base (i) is neutralized. Without quenching, there is a risk of decomposition of the obtained poly-4-hydroxybutyrate when it is isolated from the reaction mixture at ambient temperature.

In the quenching solution added in step (c), the acid or one or more of the acids is preferably selected from the group consisting of hydrohalogenic acids, oxo-acids of Cl, S, N, P and B, alkylsulfonic acids, arylsulfonic acids, mono-, di- and tri-functional carboxylic acids. Said mono-, di- and tri-functional carboxylic acids include hydroxy-functionalized mono-, di- and tri-functional carboxylic acids and unsaturated mono-, di- and tri-functional carboxylic acids.

Most preferably, in the quenching solution added in step (c), each acid is selected from the group consisting of hydrohalogenic acids, oxo-acids of Cl, S, N, P and B, alkylsulfonic acids, arylsulfonic acids, mono-, di- and tri-functional carboxylic acids as defined above.

Most preferred acids are those selected from the group consisting of hydrochloric acid HCl, perchloric acid HClO₄, nitric acid HNO₃, sulfuric acid H₂SO₄, phosphoric acid H₃PO₄, boric acid B(OH)₃, formic acid, acetic acid, acrylic acid, oxalic acid, propionic acid, lactic acid, citric acid, methanesulfonic acid and toluenesulfonic acid.

The quenching solution added in step (c) comprises one or more solvents. Suitable solvents are those in which poly-4-hydroxybutyrate is soluble.

In the quenching solution, the solvent or one or more of the solvents are preferably selected from the group consisting of halogenated aliphatic and aromatic hydrocarbons, ketones, ethers, dialkykcarbonates and dialkylsulfoxides. Most preferably, in the quenching solution added in step (c) each solvent is selected from the group consisting of halogenated aliphatic and aromatic hydrocarbons, ketones, ethers, dialkykcarbonates and dialkylsulfoxides.

As used herein, the term “hydrocarbons” is intended to include halogenated hydrocarbons.

Most preferred solvents are those selected from the group consisting of trichloromethane, deuterotrichloromethane (CDCl₃), 1,2-dichlorethan, 1,1,2,2-terachlorethane, chlorobenzene, 1,4-dioxane, anisole, dimethylether, acetone, acetophenone, dihydrolevoglucosenon, dimethylcarbonate, diethylcarbonate, dimethylsulfoxide and acetonitrile.

Said quenching solution added in step (c) preferably has a temperature in the range of from −25° C. to 20° C.

In the quenching solution, the total concentration of acids is preferable in the range of from 0.001 mol/1 to 1 mol/L, preferably in the range from 0.016 mol/L to 0.081 mol/L.

In step (c), the quenching solution is preferably added in such amount that the concentration of acid provided by the quenching solution corresponds to an amount of 1 to 50 equivalents of acid for 1 equivalent of base, preferably in the range from 4 to 20 equivalents of acid for 1 equivalent of base.

Work-up of the reaction mixture and isolation of the produced poly-4-hydroxybutyrate can be affected in any customary manner, for example by means of filtration or aqueous ex-tractive work-up, precipitation, distillative removal of the solvent or by means of a combination of some or all of these steps such as first hydrolytic work-up to remove the alkaline base and the initiator followed by removal of the organic solvent and unreacted γ-butyrolactone (I) from the organic phase by evaporation or distillation. The poly-4-hydroxybutyrate is generally obtained in sufficient purity by applying such measures or a combination thereof, rendering additional purification steps unnecessary.

The reaction can be performed continuously, semi-continuously or discontinuously. The reaction can be performed in all reactors known to a person skilled in the art which are suitable for this type of reaction. Suitable reactors are described and reviewed in the relevant literature, e. g. K. Henkel, “Reactor Types and Their Industrial Applications”, Ullmann's Encyclopedia of Industrial Chemistry, 2005, Wiley-VCH Verlag GmbH & Co. KGaA, chapter 3.3: “Reactors for gas-liquid reactions”.

An especially preferred process for the synthesis of poly-4-hydroxybutyrate comprises the steps of
(a) preparing a reaction mixture by
   (a1) forming a premix comprising
      (i) one or more bases selected from the group consisting of lithium tertbutoxide, sodium tertbutoxide, potassium tertbutoxide and potassium benzylalcoholate
      and
      (ii) one or more alcohols selected from the group consisting of methanol, ethanol, polyethyleneglycol, 1,4-butanediol, 1,6-hexanediol, benzylic alcohol, 1,4-benzenedimethanol, 2,6-dichlorobenzylalcohol, 4-methylbenzylalcohol and 2,4,6-trimethylbenzylalcohol,
   (a2) providing γ-butyrolactone (I) having a temperature in the range of from −25° C. to −10° C. and a water content of 0.1 wt % or lower, wherein preferably the γ-butyrolactone (I) is dried by means of one or more oxazolidines of formula (III), (IV) or (V) as defined above
   (a3) forming a reaction mixture by charging the premix formed in step (a1) into the γ-butyrolactone provided in step (a2)
      wherein in the reaction mixture
         the molar ratio of γ-butyrolactone to the total amount of above-defined bases (i) is in the range of from 200:1 to 400:1
         and
         the molar ratio of the total amount of above-defined bases (i) to the total amount of above-defined alcohols (ii) is in the range of from 1:1 to 1:8
         wherein the reaction mixture further comprises a solvent selected from the group consisting of dichloromethane, toluene, 2-methyl-tetrahydrofurane, 1,4-dioxane, glyme, diglyme, ethyl acetate, dimethylformamide, dimethylsulfoxide and acetonitrile and mixtures thereof
(b) chemically converting the γ-butyrolactone in the reaction mixture by ring opening-polymerization to poly-4-hydroxybutyrate at a temperature in the range of from −25° C. to −10° C.
(c) quenching the ring-opening polymerization by adding a quenching solution to the reaction mixture,
   said quenching solution comprising an acid selected from the group consisting of hydrochloric acid HCl, perchloric acid HClO₄, nitric acid HNO₃, sulfuric acid H₂SO₄, phosphoric acid H₃PO₄, boric acid B(OH)₃, formic acid, acetic acid, acrylic acid, oxalic acid, propionic acid, lactic acid, citric acid, methanesulfonic acid, and toluenesulfonic acid
   dissolved in a solvent selected from the group consisting of trichloromethane, deuterotrichloromethane (CDCl₃), 1,2-dichlorethan, 1,1,2,2-terachlorethane, chlorobenzene, 1,4-dioxane, anisole, dimethylether, acetone, acetophenone, dihydrolevoglucosenon, dimethylcarbonate, diethylcarbonate, dimethyisulfoxide, acetonitrile and mixtures thereof,
   said quenching solution having a temperature in the range of from −25° C. to 20° C.

In specific preferred processes according to the invention, the base (i) is potassium tertbutoxide, and the alcohol (ii) is selected from the group consisting of benzylic alcohol, polyethyleneglycol, 1,4-butanediol, 1,6-hexanediol, benzylic alcohol, 1,4-benzenedimethanol, 4-methylbenzylalcohol and 2,4,6-trimethylbenzylalcohol.

In other specific preferred processes according to the invention, the base (i) is potassium benzylalcoholate, and the alcohol (ii) is selected from the group consisting of benzylic alcohol, polyethyleneglycol, 1,4-butanediol, 1,6-hexanediol, benzylic alcohol, 1,4-benzenedimethanol, 4-methylbenzylalcohol and 2,4,6-trimethylbenzylalcohol.

In a further aspect, there is disclosed the use of a kit comprising
(i) one or more bases comprising an alkaline metal cation
(ii) one or more alcohols
in a process for the synthesis of poly-4-hydroxybutyrate as defined above.

Specific and preferred bases (i) comprising an alkaline metal cation are as mentioned above. Specific and preferred alcohols (ii) are as mentioned above. Specific and preferred combinations of bases (i) comprising an alkaline metal cation and alcohols (ii) are as mentioned above. Preferably, the kit is used in one of the above-defined specific and preferred processes for the synthesis of poly-4-hydroxybutyrate.

In a further aspect, there is disclosed poly-4-hydroxybutyrate obtainable by the above-defined process. Preferably, the poly-4-hydroxybutyrate is obtainable by one of the above-defined specific and preferred processes.

Poly-4-hydroxybutyrate obtainable by the above-defined process preferably have one or more of the following properties
a number-average molecular weight (Mn) determined by gel permeation chromatography (GPC) in the range of from 4000 g/mol to 10000 g/mol
a weight-average molecular weight (Mw) determined by gel permeation chromatography (GPC) in the range of from 6000 g/mol to 16000 g/mol
a molecular weight distribution (Ð) (Mw/Mn) determined by gel permeation chromatography (GPC) in the range of from 1.4 to 2.0
a decomposition onset temperature (T5%) determined by thermogravimetric analysis (TGA) in the range of from 220° C. to 250° C.
a glass transition temperature (Tg) determined by differential scanning calorimetry in the range of from −40° C. to −60° C.
a crystallization temperature (Tc) determined by differential scanning calorimetry in the range of from 10° C. to 20° C.
a melting temperature (Tm) determined by differential scanning calorimetry in the range of from 50° C. to 60° C.

Methods for determining the above-mentioned parameters are known in the art. For details, see the examples section.

Preferred poly-4-hydroxybutyrates obtainable by the above-defined process are soluble in one or more solvents selected from the group consisting of tetrahydrofurane, 2-methyl tetrahydrofurane, acetone, acetonitrile, dichloromethane, dimethyl sulfoxide (=DMSO), chlorobenzene, chloroform, 1,2-dichloroethane, 1,1,2,2-tetrachloroethane, dimethyl formamide, ethyl acetate, γ-butyrolactone (=GBL), dimethyl carbonate, diethyl carbonate, dimethoxyethane (=glyme), dihydrolevoglucosenon (=cyrene), and toluene.

Potential applications of poly-4-hydroxybutyrate obtainable by the above-defined process include the manufacture of fibers suitable for reinforcing a matrix made of another polymer, i.e. fibers for forming a fiber-reinforced polymer. Such polymer reinforced by fibers made from poly-4-hydroxybutyrate has advantages with regard to recyclability, because the reinforcement fibers could easily be removed by depolymerizing the poly-4-hydroxybutyrate and distilling the resulting γ-butyrolactone from the melt of the matrix polymer, thus obtaining γ-butyrolactone as a reusable monomer, and the fiber-free matrix polymer.

Further application fields of poly-4-hydroxybutyrate obtainable by the above-defined process relate to adhesives, e. g. hotmelt adhesives or compostable adhesives, or encapsulation of crop protection products.

The polymers of the present invention can be used in seed treatment compositions and methods of treating seed. Thus, the present invention also relates to the use of these polymers in seed treatment compositions. Seed treatment is the process of applying active ingredients to seeds in order to support the germination and/or the growth. Seed treatment is applicable to a large variety of crops. Typical examples include the application of pesti-cides such as fungicides, insecticides and plant growth regulators, as well as other active ingredients such as fertilizers.

Poly-4-hydroxybutyrate obtainable by the above-defined process can be used in the form of a blend with one or more other polymers, this way increasing the content of renewables in the final part.

Besides these applications, poly-4-hydroxybutyrate obtainable by the above-defined process can be used as intermediate for the preparation of other polymers or elastomers, e.g. for home-care or cosmetic applications or for technical polymers such as polyurethanes.

Especially bifunctional poly-4hydroxybutyrates obtainable by the above-defined process can be used for the preparation of
thermoplastic polyurethanes, e.g. for extrusion applications, preferably for an extruded article, more preferably an extruded article selected from the group consisting of cable jacketing, tube and hose, injection molding applications, preferably for an injection molded article, more preferably for an injection molded article selected from the group consisting of roller, gasket, seal, railway pad, and conveyor belt, preferably with improved compression set, with improved thermal resistance and creep performance,
polyurethane foams
cast elastomers
thermoplastic copolyesters and further specialty polymers.

Poly-4-hydroxybutyrate obtainable by the above-defined process can also be used as binder in coating applications such as
conventional base coats,
water based coats,
liquid base coats, which are essentially solvent- and water-free (so called 100% systems),
solid water-free base coats such as powder coatings and pigmented powder coatings,
solvent-free, possibly pigmented powder coating dispersions such as powder slurry base coats.

Such coatings can be hardened by thermal treatment, by radiation, or by a dual cure hardening process. They are self-crosslinking or are crosslinked by external crosslinking agents.

These coatings are suitable for coating substrates like wood, paper, textiles, leather, nonwovens, plastics, glass, ceramics, mineral products, e. g. for construction, such as cement stones or fiber-cement boards, and especially metals or coated metals.

The coating process is performed according to processes known in the art, whereby at least a coating according to the invention, i.e. containing poly-4-hydroxybutyrate obtainable by the above-defined process, is applied on a substrate in the desired thickness, and then volatile components are removed. This process can be repeated once or multiple times if desired. Application of the coating on a substrate can be done according to known processes such as spraying, stopping, coating with a doctor knife, brushing, rolling, or casting. Strength of coating is typically from 3 to 1000 g/m² and preferably 10 to 200 g/m².

Poly-4-hydroxybutyrates obtainable by the above-defined process can also be used in the production of printing inks or printed coatings, being used as additives such as dispersing aids, stabilizers, or bonding agents. A preferred application is the use as binder for printing inks or printed coatings.

Furthermore, poly-4-hydroxybutyrates obtainable by the above-defined process can also be used in cosmetic and dermatological formulations as rheology modifiers, especially as thickeners, especially as oil thickening polymers suitable for cosmetic applications.

### EXAMPLES

The following examples are meant to further explain and illustrate the present invention without limiting its scope.

### Test of Different Bases (i) and Alcohol Initiators (ii) (Examples 1-20)

### Preparation 6.5 Mmol Scale (Examples 4-7, 12-14. Cf. Table 1)

The ring-opening-polymerization of γ-butyrolactone (GBL) was performed in a sealed 10 mL vial. In an Argon filled glovebox, the 10 mL vial was charged with GBL (500 μL, 6.50 mmol, 1.0 eq) and sealed with a septum. A separate 1 mL vial was charged with the base indicated in table 1 (0.125 mol % to 0.5 mol % relative to GBL, cf. table 1) followed by the solvent 2-MeTHF (65 μL, resulting in a concentration of GBL of 100 M in the reaction mixture to be formed) and the alcohol initiator indicated in table 1 (0.5 mol % to 1.0 mol % relative to GBL, cf. table 1) and sealed (step (a1)). The obtained premix Base/Initiator/Solvent was homogenized for 5 min. If the solid constituents of the premix were not completely solubilized, the premix was used as a suspension. The vials were taken out of the glovebox. The vial containing the GBL was immersed in the cooling bath at −20° C. (step (a2)). After 30 min equilibration at the desired temperature, a reaction mixture was formed (step (a3)) and the ring-opening polymerization of GBL (step (b)) was initiated by dropwise addition of the premix Base/Initiator/Solvent via a gastight syringe. After 4 hours resp. 14 hours (as indicated in table 1) at −20° C., the polymerization was quenched (step (c)) by addition of 4 mL of a cold (−20° C.) acetic acid/CHCl₃ (5 μL/mL) solution, until the precipitated polymer was redissolved at −20° C. The quenched reaction mixture was analyzed by ¹H-NMR to obtain the percentage of converted monomer and yield.

### Preparation 130 Mmol Scale (Examples 1-3, 8-11, 15-20. Cf. Table 1)

The ring-opening polymerization of γ-butyrolactone was performed in a flame-dried 100 mL round bottom flask. In an Argon filled glovebox, the flask was charged with GBL (10 mL, 130 mmol, 1.0 eq) and sealed with a septum. A separate 4 mL vial was charged with the base indicated in table 1 (0.125 mol % to 0.25 mol % relative to GBL, cf. table 1) followed by the solvent 2-MeTHF (1.3 mL, resulting in a concentration of GBL of 100 M in the reaction mixture to be formed) and the alcohol initiator indicated in table 1 (0.5 mol % to 1.0 mol %, relative to GBL, cf. table 1) and sealed (step (a1)). The obtained premix Base/initiator/Solvent was homogenized for 5 min. If the solid constituents of the premix were not completely solubilized, the premix was used as a suspension. The reactor and the vial were taken out of the glovebox. The round bottom flask was immersed in the cooling bath at −20° C. (step (a2)). After 40 min equilibration at the desired temperature, a reaction mixture was formed (step (a3)) and the ring-opening polymerization of GBL (step (b)) was initiated by dropwise addition of the premix Base/Initiator/Solvent via a gastight syringe. After 4 hours resp. 24 hours (as indicated in table 1) at −20° C., the polymerization (step (c)) was quenched by addition of 40 mL of a cold (−20° C.) acetic acid/DCM (5 μL/mL) solution, until the precipitated polymer was redissolved at −20° C. The quenched reaction mixture was washed with distilled water (3×100 mL) and then the volatile constituents were evaporated using a rotative evaporator (at 35° C. until 20 mbar was reached). The remaining viscous liquid was precipitated using cold MeOH:H₂O 9:1, filtered, washed with cold MeOH:H₂O 9:1 and dried under high vacuum (0.1 mbar) for 24 hours.

TABLE 1

| | | 220190 | | | | | 220190WO01 | | | | |
|---|---|---|---|---|---|---|---|---|---|---|---|
| BASF SE | | Mol Ratio | Scale | t | T | | Yield | Mₙ | Mₙ | M_{w} | Ð |
| Example | Initiator (I)/Base (B) | GBL/I/B | (mmol) | (h) | (° C.) | Solvent | (%)^{[a]} | (g/mol)^{[d]} | (g/mol)^{[e]} | (g/mol)^{[e]} | (M_{w}/Mₙ)^{[e]} |
| 1 | BnOH/tBuOK | 1400/4/1 | 130 | 4 | −20 | 2-MeTHF | 92^{[b]} | 8050 | 9310^{e} | 15330^{e} | 1.65^{e} |
| 2 | BnOH/tBuOK^{[c]} | 400/4/1 | 130 | 4 | −20 | 2-MeTHF | 94^{[b]} | 8002 | 10430^{e} | 15750^{e} | 1.51^{e} |
| 3 | BnOH/tBuOK | 800/4/1 | 130 | 4 | −20 | 2-MeTHF | 52^{[b]} | 8647 | 10670^{e} | 17230^{e} | 1.61^{e} |
| 4 | BnOH/tBuOK | 400/4/1 | 6.5 | 4 | −20 | 2-MeTHF | 70 | N.D. | N.D. | N.D. | N.D. |
| 5 | BnOH/tBuOK | 400/4/1 | 6.5 | 14 | −20 | 2-MeTHF | 75 | N.D. | N.D. | N.D. | N.D. |
| 6 | BnOH/tBuOK | 800/4/1 | 6.5 | 14 | −20 | 2-MeTHF | 69 | N.D. | N.D. | N.D. | N.D. |
| 7 | BnOH/BnOK | 400/4/1 | 6.5 | 4 | −20 | 2-MeTHF | 64 | N.D. | N.D. | N.D. | N.D. |
| 8 | BnOH/tBuONa | 400/4/1 | 130 | 4 | −20 | 2-MeTHF | 61^{[b]} | 6506 | N.D. | N.D. | N.D. |
| 9 | BnOH/tBuOLi | 400/4/1 | 130 | 4 | −20 | 2-MeTHF | 12^{[b]} | 2905 | N.D. | N.D. | N.D. |
| 10 | 1,4-benzenedimethanol | 400/4/1 | 130 | 4 | −20 | 2-MeTHF | 54^{[b]} | 9684 | 9640^{e} | 15300^{e} | 1.58^{e} |
| | (BDM)/tBuOK | | | | | | | | | | |
| 11 | 1,4-BDM/tBuOK | 800/4/1 | 130 | 24 | −20 | 2-MeTHF | 41^{[b]} | 7027 | N.D. | N.D. | N.D. |
| 12 | 1,4-BDM/tBuOK | 400/2/1 | 6.5 | 4 | −20 | 2-MeTHF | 27 | N.D. | N.D. | N.D. | N.D. |
| 13 | 1,4-BDM/tBuOK | 200/2/1 | 6.5 | 4 | −20 | 2-MeTHF | 36 | N.D. | N.D. | N.D. | N.D. |
| 14 | 1,4-BDM/tBuOK | 400/4/1 | 6.5 | 4 | −20 | 2-MeTHF | 41 | N.D. | N.D. | N.D. | N.D. |
| 15 | 1,4-butanediol/tBuOK | 400/1/1 | 130 | 4 | −20 | 2-MeTHF | 40^{[b]} | 3198 | 3950^{e} | 5420^{e} | 1.37^{e} |
| 16 | 1,6-hexanediol/tBuOK | 400/2/1 | 130 | 4 | −20 | 2-MeTHF | 42^{[b]} | 8648 | 8650^{e} | 13590^{e} | 1.57^{e} |
| 17 | MeOH/tBuOK | 400/4/1 | 130 | 4 | −20 | 2-MeTHF | 71^{[b]} | 11110 | N.D. | N.D. | N.D. |
| 18 | 4-Me—C₆H₄CH₂OH/tBuOK | 400/4/1 | 130 | 4 | −20 | 2-MeTHF | 76^{[b]} | 6400 | N.D. | N.D. | N.D. |
| 19 | 2,6-Cl—C₆H₃CH₂OH/tBuOK | 400/4/1 | 130 | 4 | −20 | 2-MeTHF | 89^{[b]} | 8579 | N.D. | N.D. | N.D. |
| 20 | 2,4,6-Me—C₆H₂CH₂OH/tBuOK | 400/4/1 | 130 | 4 | −20 | 2-MeTHF | 83^{[b]} | 6821 | 9080^{e} | 13640^{e} | 1.50^{e} |

^{[a]}Determined by ¹H-NMR using hexamethyldisiloxane as internal standard;
^{[b]}Isolated yield;
^{[c]}Potassium tert-butoxide, 2M (25% w/w)-Solution in 2-MeTHF;
^{[d]}Mₙ (number-average molar mass in g/mol) was determined by ¹H-NMR of the pure polymer by comparing the integration of the signal from the initiator benzyl alcohol [5.12 ppm], 1,4-BDM [5.09 ppm], 1,4-BDO [3.66 ppm], 1,6-HDO [3.66 ppm], MeOH [3.47 ppm] as A, with the CH₂ signal from the poly-4-hydroxybutyrate at 4.12 ppm as B.
Mₙ was calculated the following equation, protons are written N_{A} and N_{B} for A and B:
Mₙ = ((B/N_{B})/(A/N_{A}))*Mw(γ-butyrolactone) + Mw(initiator).
^{[e]}determined from GPC in THF
Note:
The Mₙ values determined by NMR usually differ from the Mₙ values determined via GPC. As known by the skilled person, GPC gives relative values depending on the applied standard.
“N.D.” means that the parameter was not determined.

### Test of Different Solvents for the Reaction Mixture

### Preparation 6.5 Mmol Scale (Examples 4 and 21-29)

The ring-opening-polymerization of γ-butyrolactone (GBL) was performed in a sealed 10 mL vial. In an Argon filled glovebox, the 10 mL vial was charged with GBL (500 μL, 6.50 mmol, 1.0 eq) and sealed with a septum. A separate 1 mL vial was charged with the base potassium tert-butoxide (0.25 mol % relative to GBL) followed by the solvent indicated in table 2 (65 μL, resulting in a concentration of GBL of 100 M in the reaction mixture to be formed) and the initiator benzyl alcohol (1.0 mol % relative to GBL) and sealed (step (a1)). The obtained premix Base/Initiator/Solvent was homogenized for 5 min. If the solid constituents of the premix were not completely solubilized, the premix was used as a suspension. The vials were taken out of the glovebox. The vial containing the GBL was immersed in the cooling bath at −20° C. (step (a2)). After 30 min equilibration at the desired temperature, a reaction mixture was formed (step (a3)) and the ring-opening polymerization of GBL (step (b)) was initiated by dropwise addition of the premix Base/Initiator/Solvent via a gastight 30 syringe. After 4 hours resp. 14 hours (as indicated in table 2) at −20° C., the polymerization was quenched (step (c)) by addition of 4 mL of a cold (−20° C.) acetic acid/CHCl₃ (5 μL/mL) solution, until the precipitated polymer was redissolved at −20° C. The quenched reaction mixture was analyzed by ¹H-NMR to obtain the percentage of converted monomer and yield.

TABLE 2

| | Initiator (I)/ | Mol Ratio | Scale | t | T | | Yield |
|---|---|---|---|---|---|---|---|
| Example | Base (B) | GBL/I/B | (mmol) | (h) | (° C.) | Solvent | (%)^{[a]} |
| 4 | BnOH/tBuOK | 400/4/1 | 6.5 | 4 | −20 | 2-MeTHF | 70 |
| 21 | BnOH/tBuOK | 400/4/1 | 6.5 | 4 | −20 | CH₂Cl₂ | 50 |
| 22 | BnOH/tBuOK | 400/4/1 | 6.5 | 4 | −20 | 1,4-Dioxane | 54 |
| 23 | BnOH/tBuOK | 400/4/1 | 6.5 | 4 | −20 | EtOAc | 83 |
| 24 | BnOH/tBuOK | 400/4/1 | 6.5 | 4 | −20 | Toluene | 66 |
| 25 | BnOH/tBuOK | 400/4/1 | 6.5 | 4 | −20 | DMSO | 26 |
| 26 | BnOH/tBuOK | 400/4/1 | 6.5 | 4 | −20 | DMF | 36 |
| 27 | BnOH/tBuOK | 400/4/1 | 6.5 | 4 | −20 | Glyme | 50 |
| 28 | BnOH/tBuOK | 400/4/1 | 6.5 | 4 | −20 | Diglyme | 56 |
| 29 | BnOH/tBuOK | 400/4/1 | 6.5 | 4 | −20 | Acetonitrile | 22 |

^{[a]}Determined by ¹H-NMR using hexamethyldisiloxane as internal standard.

### Preparation 6.5 Mmol Scale (Examples 30-32. Cf. Table 3)

The ring-opening polymerization of γ-butyrolactone (GBL) was performed in a sealed 10 mL vial. In an Argon filled glovebox, the 10 mL vial was charged with GBL (500 μL, 6.50 mmol, 1.0 eq) and sealed with a septum. A separate 1 mL vial was charged with the base potassium tert-butoxide (0.25 mol % relative to GBL) followed by the solvent indicated in table 3 (65 μL, resulting in a concentration of GBL of 100 M in the reaction mixture to be formed) and (except for example 30, which is a comparison example) the initiator indicated in table 3 (1 mol % relative to GBL) and sealed (step (a1)). The obtained premix Base/initiator/Solvent was homogenized for 5 min. The vials were taken out of the glovebox. The vial containing the GBL was immersed in the cooling bath at −20° C. (step (a2)). After 30 min equilibration at the desired temperature, a reaction mixture was formed (step (a3)) and the ring-opening polymerization of GBL (step (b)) was initiated by dropwise addition of the premix Base/initiator/Solvent via a gastight syringe. After 4 hours at −20° C., the polymerization was quenched (step (c)) by addition of 4 mL of a cold (−20° C.) acetic acid/CHCl₃ (5 μL/mL) solution, until the precipitated polymer was redissolved at −20° C. The quenched reaction mixture was analyzed by ¹H-NMR to obtain the percentage of converted monomer and yield.

### Preparation 130 Mmol Scale (Example 33. Cf. Table 3)

The ring-opening polymerization of γ-butyrolactone (GBL) was performed in a flame-dried 100 mL round bottom flask. In an Argon filled glovebox, the flask was charged with GBL (10 mL, 130 mmol, 1.0 eq) and sealed with a septum. A separate 4 mL vial was charged with the base potassium tert-butoxide (0.25 mol % relative to GBL) followed by the solvent ethyl acetate (1.3 mL, resulting in a concentration of GBL of 100 M in the reaction mixture to be formed) and the initiator benzyl alcohol (1.0 mol % relative to GBL) and sealed (step (a1)). The obtained premix Base/Initiator/Solvent was homogenized for 5 min. The reactor and the vial were taken out of the glovebox. The round bottom flask was immersed in the cooling bath at −20° C. (step (a2)). After 40 min equilibration at the desired temperature, a reaction mixture was formed (step (a3)) and the ring-opening polymerization of GBL (step (b)) was initiated by dropwise addition of the premix Base/initiator/Solvent via a gastight syringe. After 4 hours at −20° C., the polymerization was quenched (step (c)) by addition of 40 mL of a cold (−20° C.) acetic acid/DCM (5 μL/mL) solution, until the precipitated polymer was redissolved at −20° C. The quenched reaction mixture was washed with distilled water (3×100 mL) and then the volatile constituents were evaporated using a rotative evaporator (at 35° C. until 20 mbar was reached). The remaining viscous liquid was precipitated using cold MeOH:H₂O 9:1, filtered, washed with cold MeOH:H₂O 9:1 and dried under high vacuum (0.1 mbar) for 24 hours.

TABLE 3

| | Initiator (I)/ | Mol Ratio | Scale | t | T | | Yield |
|---|---|---|---|---|---|---|---|
| Example | Base (B) | GBL/I/B | (mmol) | (h) | (° C.) | Solvent | (%)^{[a]} |
| 30 | tBuOK | 400/0/1 | 6.5 | 4 | −20 | EtOAc | 34 |
| 31 | EtOH/tBuOK | 400/4/1 | 6.5 | 4 | −20 | EtOAc | 40 |
| 32 | BnOH/EtOAc/tBuOK | 400/4/4/1 | 6.5 | 4 | −20 | 2-MeTHF | 67 |
| 33 | BnOH/tBuOK | 400/4/1 | 130 | 4 | −20 | EtOAc | 80^{[b]} |

^{[a]}Determined by ¹H-NMR using hexamethyldisiloxane as internal standard;
^{[b]}Isolated yield

### Test of Different Solvents for Quenching in Step (c) (Examples 4 and 34-47)

### Preparation 6.5 Mmol Scale (Examples 4, 34-39 and 41-47. Cf. Table 4)

The ring-opening polymerization of γ-butyrolactone (GBL) was performed in a sealed 10 mL vial. In an Argon filled glovebox, the 10 mL vial was charged with GBL (500 μL. 6.50 mmol) and sealed with a septum. A separate 1 mL vial was charged with the base potassium tert-butoxide (1.83 mg, 0.016 mmol) followed by the solvent 2-MeTHF (65.0 μL, resulting in a concentration of GBL of 100 M in the reaction mixture to be formed) and the initiator benzyl alcohol (6.7 μL, 0.065 mmol), and sealed (step (a1)). The obtained premix Base/Initiator/2-MeTHF was homogenized for 5 min. The vials were taken out of the glovebox. The vial containing the GBL was immersed in the cooling bath at −20° C. (step (a2)). After 30 min equilibration at the desired temperature, a reaction mixture was formed (step (a3)) and the ring-opening polymerization of GBL (step (b)) was initiated by dropwise addition of the premix Base/Initiator/2-MeTHF via a gastight syringe. After 4 hours at −20° C., the polymerization was quenched (step (c)) by addition of a cold (−20° C.) quenching solution comprising acetic acid (acid concentration 5 mol % relative to GBL) in 4 mL of the solvent indicated in table 4, until the precipitated polymer was redissolved at −20° C. If the polymer did not redissolve at −20° C., the reaction mixture was warmed up to +22° C. The quenched reaction mixture was analyzed by ¹H-NMR to obtain the percentage of converted monomer and yield.

### Preparation 130 Mmol Scale (Example 40. Cf. Table 4)

The ring-opening polymerization of γ-butyrolactone was performed in a flame-dried 100 mL round bottom flask. In an Argon filled glovebox, the flask was charged with γ-butyrolactone (10 mL, 130 mmol, 1.0 eq) and sealed with a septum. A separate 4 mL vial was charged with the base potassium tert-butoxide (0.25 mol % relative to GBL) followed by the solvent 2-MeTHF (1.3 mL, resulting in a concentration of GBL of 100 M in the reaction mixture to be formed) and the initiator benzyl alcohol (1.0 mol % relative to GBL), and sealed (step (a1)). The premix Base/Initiator/Solvent was homogenized for 5 min. The reactor (i.e. the flask) and the vial were taken out of the glovebox. The round bottom flask was immersed in the cooling bath at −20° C. (step (a2)). After 40 min equilibration at the desired temperature, a reaction mixture was formed (step (a3)) and the ring-opening polymerization of GBL (step (b)) was initiated by dropwise addition of the premix Base/Initiator/Solvent via a gastight syringe. After 4 hours at −20° C., the polymerization was quenched (step (c)) by addition of 40 mL of a cold (−20° C.) acetic acid/acetone (5 μL/mL) solution and warmed to +22° C. until the polymer was redissolved. The quenched reaction mixture was washed with distilled water (3×100 mL) and then the volatile constituents were evaporated using a rotative evaporator (at 35° C. until 20 mbar was reached). The remaining viscous liquid was precipitated using cold MeOH:H₂O 9:1, filtered, washed with cold MeOH:H₂O 9:1 and dried under high vacuum (0.1 mbar) for 24 hours.

TABLE 4

| Example | Solvent for quenching | Scale (mmol) | Yield^{[a]} |
|---|---|---|---|
| 4 | CHCl₃ | 6.5 | 70 |
| 34 | Acetophenone | 6.5 | 18 |
| 35 | dihydrolevoglucosenon | 6.5 | 21 |
| 36 | Anisole | 6.5 | 26 |
| 37 | 1,4-dioxane | 6.5 | 31 |
| 38 | DME | 6.5 | 32 |
| 39 | Acetone | 6.5 | 41 |
| 40 | Acetone | 130 | 65^{[b]}, Mₙ = |
| | | | 8524 Da^{[c]} |
| 41 | (MeO)₂CO | 6.5 | 45 |
| 42 | DMSO | 6.5 | 50 |
| 43 | (EtO)₂CO | 6.5 | 51 |
| 44 | Chlorobenzene | 6.5 | 53 |
| 45 | Acetonitrile | 6.5 | 54 |
| 46 | 1,2-DCE^{[d]} | 6.5 | 68 |
| 47 | 1,1,2,2-TCE^{[e]} | 6.5 | 69 |

^{[a]}Determined by ¹H-NMR using hexamethyldisiloxane as internal standard;
^{[b]}Isolated yield;
^{[c]}Mₙ (number-average molar mass in Da) was determined by ¹H-NMR of the pure polymer by comparing the integration of the CH₂ signal from the benzyl alcohol at 5.12 ppm A, with the CH₂ signal from the poly-4-hydroxybutyrate at 4.12 ppm B, due to the presence of only 1 benzyl alcohol molecule per polymer chain.
Mₙ was calculated the following equation, protons are not taken into account here as two CH₂ are being compared:
Mₙ = (B/A)*Mw(γ-butyrolactone) + Mw(benzyl alcohol)
^{[d]}1,2-DCE = 1,2-dichloroethane
^{[e]}1,1,2,2-TCE = 1,1,2,2-tetrachloroethane

### Test of Different Acids for Quenching in Step (c) (Examples 4 and 48-61)

### Preparation 6.5 Mmol Scale (Examples 4 and 48-61. Cf. Table 5)

The ring-opening polymerization of γ-butyrolactone (GBL) was performed in a sealed 10 mL vial. In an Argon filled glovebox, the 10 mL-vial was charged with GBL (500 μL, 6.50 mmol) and sealed with a septum. A separate 1 mL vial was charged with the base potassium tert-butoxide (1.83 mg, 0.016 mmol) followed by the solvent 2-MeTHF (65.0 μL, resulting in a concentration of GBL of 100 M in the reaction mixture to be formed) and the initiator benzyl alcohol (6.7 μL, 0.065 mmol) and sealed (step (a1)). The obtained premix Base/Initiator/2-MeTHF was homogenized for 5 min. The vials were taken out of the glovebox. The vial containing the GBL was immersed in the cooling bath at −20° C. (step (a2)).

After 30 min equilibration at the desired temperature, a reaction mixture was formed (step (a3)) and the ring-opening polymerization of GBL (step (b)) was initiated by dropwise addition of the premix Base/Initiator/2-MeTHF via a gastight syringe. After 4 hours at −20° C., the polymerization was quenched (step (c)) by addition of 4 mL of cold (−20° C.) quenching solution comprising the acid indicated in table 5 (acid concentration 1-5 mol % relative to GBL) in 4 mL of the solvent indicated in table 5 until the precipitated polymer was redissolved at −20° C. If the polymer did not redissolve at −20° C., the reaction mixture was warmed up to +22° C. The quenched reaction mixture was analyzed by ¹H-NMR to obtain the percentage of converted monomer and yield.

TABLE 5

| | | | Amount | | |
|---|---|---|---|---|---|
| | | | of acid | | |
| Exam- | Solvent for | Acid for | relative | pKa in | |
| ple | quenching | quenching | to tBuOK | H₂O | Yield^{[a]} |
| 4 | CHCl₃ | AcOH 98% | 20 eq | +4.75 | 70 |
| 48 | CDCl₃/ | HClO₄ 70% | 12 eq | −10 | 14 |
| | Acetone, 4:1 | | | | |
| 49 | CDCl₃/ | H₂SO₄ 98% | 4 eq | −3.0 | 32 |
| | Acetone, 4:1 | | | | |
| 50 | CDCl₃/ | MeSO₃H | 12 eq | −2.6 | 29 |
| | Acetone, 4:1 | | | | |
| 51 | CDCl₃ | pTSA | 12 eq | −2.1 | 64 |
| 52 | CDCl₃/ | HCl 37% | 12 eq | −1.1 | 54 |
| | Acetone, 4:1 | | | | |
| 53 | CDCl3/ | HNO₃ 70% | 12 eq | −1.3 | 66 |
| | Acetone, 4:1 | | | | |
| 54 | CDCl₃/ | oxalic acid 80% | 12 eq | +1.27 | 56 |
| | Acetone, 1:1 | (in H₂O) | | | |
| 55 | CDCl₃/ | H₃PO₄ 85% | 12 eq | +2.12 | 55 |
| | Acetone, 1:1 | (in H₂O) | | | |
| 56 | CDCl₃/ | citric acid 40% | 12 eq | +3.1 | 51 |
| | Acetone, 2:3 | (in H₂O) | | | |
| 57 | CDCl₃/ | formic acid 85% | 12 eq | +3.75 | 66 |
| | Acetone, 4:1 | (in H₂O) | | | |
| 58 | CDCl₃/ | lactic acid 85% | 12 eq | +3.86 | 66 |
| | Acetone, 4:1 | (in H₂O) | | | |
| 59 | CDCl₃/ | acrylic Acid | 12 eq | +4.25 | 65 |
| | Acetone, 4:1 | | | | |
| 60 | CDCl₃ | propanoic acid | 12 eq | +4.87 | 61 |
| 61 | CDCl₃/ | B(OH)₃ 50% | 12 eq | +9.5 | 55 |
| | Acetone, 2:3 | (in H₂O) | | | |

^{[a]}Determined by ¹H-NMR using hexamethyldisiloxane as internal standard.

### Testing of different water scavengers for γ-Butyrolactone (Examples 62-68)

### Preparation on a 130 Mmol Scale Comprising Drying of GBL by Adding CaH₂ (Example 62)

The ring-opening polymerization of γ-butyrolactone (GBL) was performed under N₂ atmosphere in a 50 mL Schlenk round bottom flask which was previously dried in an oven at 120° C. overnight. The flask was charged with calcium hydride (112 mg, 1 wt %) and GBL (10.0 mL, 130.1 mmol) and was flushed with N₂ and sealed. The mixture in the sealed flask was then heated to 60° C. during 2 hours. After cooling to room temperature, the sealed flask was immersed in a cooling bath at −20° C. during 30 min (step (a2)). A separate dry vial was charged with the base (anhydrous solution of potassium tert-butoxide in 2-MeTHF, 2 M, 25 wt. %, 0.170 mL, 0.25 mol % relative to GBL), the initiator (anhydrous benzyl alcohol, 0.135 mL, 1.30 mmol) and anhydrous Me-THF (1.130 mL, resulting in a concentration of GBL of 100 M in the reaction mixture to be formed), and sealed (step (a1)). The obtained premix Base/Initiator/Solvent was homogenized for 5 min, and cooled to −20° C. for 10 minutes. A reaction mixture was formed (step (a3)) by quickly adding the premix to the cold GBL via a gastight syringe to start the ring-opening polymerization of GBL (step (b)). After 4 hours at −20° C., the polymerization was quenched (step (c)) by addition of a cold (−20° C.) quenching solution comprising acetic acid (2 mol. % relative to GBL) dissolved in 40 mL dichloromethane before gently crushing the white solid polymer formed. The quenched reaction mixture was filtered and washed with distilled water (3×80 mL) and then the volatile constituents were evaporated using a rotative evaporator (40° C., until 20 mbar was reached). The remaining viscous liquid was precipitated using cold MeOH, filtered, washed with cold MeOH and dried under vacuum on rotative evaporator to obtain the 4-hydroxybutyrate (3.443 g, 40.0 mmol, 30% yield).

### Preparation with Incozol 2 (Formula (IV) on a 65.05 Mmol Scale (Examples 63-68)

The ring-opening polymerization of γ-butyrolactone was performed under N₂ atmosphere in a 50 mL Schlenk flask which was previously dried in an oven at 120° C. overnight. After performing 3 cycles of high vacuum/N₂ the dried flask was sealed and charged with GBL (5.0 mL, 65.05 mmol) via a gastight syringe. The water scavenger Incozol 2 (Incorez ltd., 0.1 to 0.3 mol. %) was added to the GBL and the resulting mixture was stirred for 1 hours at ambient temperature. The sealed flask was then immersed in a cooling bath at −20° C. during 30 min (step (a2)). A separate dry vial was charged with the base (anhydrous solution of potassium tert-butoxide in 2-MeTHF, 2 M, 25 wt. %, 0.35 to 0.6 mol %, relative to GBL, cf. table 6), the initiator indicated in table 6 (anhydrous benzyl alcohol or polyethylene glycol M_{w}=400 (PEG 400), 0.25 to 1.0 mol % relative to GBL, cf. table 6) and anhydrous Me-THF (65.0 μL, resulting in a concentration of GBL of 100 M in the reaction mixture to be formed), and sealed (step (a1)). The obtained premix Base/Initiator/Solvent was homogenized for 5 min and cooled to −20° C. for 10 minutes. A reaction mixture was formed (step (a3)) by quickly adding the premix to the cold GBL via a gastight syringe to start the ring-opening polymerization of GBL (step (b)). After 4 hours at −20° C., the polymerization was quenched (step (c)) by addition of a cold (−20° C.) quenching solution comprising acetic acid (2 mol % relative to GBL) dissolved in 40 mL dichloromethane before gently crushing the white solid polymer formed. The quenched reaction mixture was washed with distilled water (3×50 mL) and then the volatile constituents were evaporated using a rotative evaporator (40° C., until 20 mbar was reached). The remaining viscous liquid was precipitated using cold MeOH, filtered, washed with cold MeOH and dried under vacuum on rotative evaporator to obtain the corresponding poly-γ-butyrolactone.

TABLE 6

| | Initiator (I)/ | Mol Ratio | Scale | Water | mol % water | | Yield |
|---|---|---|---|---|---|---|---|
| Example | Base (B) | GBL/I/B | (mmol) | scavenger | scavenger | Solvent | (%)^{[b]} |
| 62 | BnOH/tBuOK | 1400/4/1 | 130 | CaH₂^{[a]} | 1.0 | 2-Me—THF | 30 |
| 63 | BnOH/tBuOK | 500/5/3 | 65 | Incozol 2 | 0.3 | 2-Me—THF | 53 |
| 64 | BnOH/tBuOK | 300/3/1 | 65 | Incozol 2 | 0.1 | 2-Me—THF | 41 |
| 65 | BnOH/tBuOK | 200/2/1 | 65 | Incozol 2 | 0.2 | Chloro- | 30 |
| | | | | | | benzene | |
| 66 | PEG 400/tBuOK | 400/1/4 | 65 | Incozol 2 | 0.2 | 2-Me—THF | 29 |
| 67 | PEG 400/tBuOK | 200/1/1 | 65 | Incozol 2 | 0.2 | 2-Me—THF | 26 |
| 68 | PEG 400/tBuOK | 200/2/1 | 65 | Incozol 2 | 0.2 | 2-Me—THF | 31 |

^{[a]}GBL mixed with CaH₂ (1 wt %) and heated to 60° C. for 2 hours prior to the addition of Base/Initiator/Solvent premix
^{[b]}Isolated yield

Physical parameters of 4-hydroxybutyrate synthesized in examples 62-88 in the presence of a water scavenger are compiled in table 7. “N.D.” means that the parameter was not determined.

TABLE 7

| | M_{n exp} | M_{w exp} | Ð | T_{5%} | T_{g} | T_{c} | Tₘ |
|---|---|---|---|---|---|---|---|
| Example | (g/mol) | (g/mol) | (M_{w}/Mₙ) | (° C.) | (° C.) | (° C.) | (° C.) |
| 60 | 7861 | 13571 | 1.73 | 225 | −57.2 | 11.9 | 54.6 |
| 61 | 4259 | 6657 | 1.56 | 227 | −46.7 | 17.5 | 58.9 |
| 62 | 8592 | 13263 | 1.54 | 247 | −49.3 | 16.1 | 59.7 |
| 63 | 6739 | 13001 | 1.93 | N.D. | N.D. | N.D. | N.D. |
| 64 | 8791 | 15497 | 1.76 | N.D. | N.D. | N.D. | N.D. |
| 65 | 8221 | 13655 | 1.66 | N.D. | N.D. | N.D. | N.D. |
| 66 | 9083 | 13017 | 1.43 | N.D. | N.D. | N.D. | N.D. |

Mₙ, M_{w} and Ð were determined from GPC in THF.
Decomposition onset temperature (T_{5%}) was measured by TGA.
Glass transition temperature (T_{g}), crystallization temperature (T_{c}) and melting temperature (Tₘ) were measured by DSC.

### Methods:

The number-average molecular weight (Mₙ), the weight-average molecular weight (M_{w}) and the molecular weight distribution (Ð) were determined by gel permeation chromatography (GPC). The measurements were performed at 40° C. with THF as eluent and a flow rate of 1 mL/min on an Agilent 1260 Infinity II GPC instrument equipped with two PLgel 3 μm mixed-E columns. The polymer concentration in THF was 4 mg/mL and 1,2-dichiorobenzene was used as a reference. A conventional calibration with polystyrene standards was used for the molecular weight determination.

Thermogravimetric analyses (TGA) were performed on a Mettler Toledo STAR^{e} DSC/TGA analyzer. Polymer samples were heated from 20 to 500° C. in N₂ atmosphere at a rate of 10° C./min.

Differential scanning calorimetry (DSC) measurements were performed on a Netzsch DSC 200 F3 Maia apparatus under N₂ atmosphere, with a flow rate of 30 mL/min. After a first scan allowing to reset thermal history, a second heating was performed from −80° C. to 120° C. with a heating and cooling rate of 10° C./min.

### Comparative Example 1 (Non-Inventive): GBL Quickly Added to Cold Base/Initiator/Solvent

The ring-opening polymerization of γ-butyrolactone was performed in a flame-dried 100 mL round bottom flask. In an Argon filled glovebox, the flask was charged with the base potassium tert-butoxide (0.036 g, 0.325 mmol, 0.25 mol % relative to GBL) followed by the solvent 2-MeTHF (1.301 mL. resulting in a concentration of GBL of 100 M in the reaction mixture to be formed) and the initiator benzyl alcohol (0.135 mL, 1.301 mmol, 1.0 mol % relative to GBL) and sealed with a septum. A separate 20 mL sealed vial was charged with GBL (10 mL, 130 mmol, 1.0 eq.). The premix Base/Initiator/Solvent was homogenized for 5 min. The reactor (i.e. the flask) and the vial were taken out of the glovebox. The round bottom flask with Base/Initiator/Solvent was immersed in the cooling bath at −20° C. After 40 min equilibration at the desired temperature, a reaction mixture was formed and the polymerization was initiated by quick addition of the γ-butyrolactone via a syringe. After 4 hours at −20° C., the polymerization was quenched by addition of 40 mL of cold (−20° C.) acetic acid/CHCl₃ (2 μL/mL) solution, until the precipitated polymer was redissolved at −20° C. The quenched reaction mixture was washed with distilled water (3×100 mL) and then the volatile constituents were evaporated using a rotative evaporator (at 35° C. until 20 mbar was reached). The remaining viscous liquid was precipitated using cold MeOH:H2O 9:1, filtered, washed with cold MeOH:H2O 9:1 and dried under high vacuum (0.1 mbar) for 24 hours, to afford the corresponding poly-γ-butyrolactone (5.72 g, 66.4 mmol, 51% yield, Mₙ=7161 g/mol).

Mₙ (average mass in g/mol or Da) was determined by ¹H-NMR of the pure polymer by comparing the integration of the CH₂ signal from the benzyl alcohol at 5.12 ppm A, with the CH₂ signal from the poly-4-hydroxybutyrate at 4.12 ppm B, due to the presence of only 1 benzyl alcohol molecule per polymer chain. Mₙ was calculated using the following equation, protons are not taken into account here as two CH₂ are being compared:

$${M}_{n} = ( B / A ) * Mw ( γ - butyrolactone ) + Mw ( benzyl alcohol )$$

1.-15. (canceled)

16. A process for the synthesis of poly-4-hydroxybutyrate, said process comprising the steps of
(a) preparing a reaction mixture comprising:
(i) one or more bases comprising an alkali metal cation,
(ii) one or more alcohols,
and 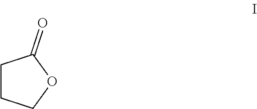
(iii) γ-butyrolactone (I),
wherein in the reaction mixture the molar ratio of γ-butyrolactone (iii) to the total amount of (i) bases comprising an alkali metal cation is 200:1 or higher,
wherein preparing the reaction mixture comprises:
(a1) forming a premix comprising:
(i) one or more bases comprising an alkali metal cation
and
(ii) one or more alcohols,
(a2) providing (iii) γ-butyrolactone having a temperature of −25° C. or more,
(a3) obtaining the reaction mixture by charging the premix formed in step (a1) into the γ-butyrolactone having a temperature of −25° C. or higher provided in step (a2), and
(b) chemically converting the γ-butyrolactone in said reaction mixture by ring opening-polymerization to poly-4-hydroxybutyrate at a temperature of −25° C. or higher.

17. The process according to claim 16, wherein
(i) the one or more bases comprising an alkali metal cation are selected from the group consisting of lithium alkoxides, sodium alkoxides and potassium alkoxides.

18. The process according to claim 16, wherein
(ii) the one or more alcohols are selected from the group consisting of methanol, ethanol, ethyleneglycol, diethyleneglycol, polyethyleneglycol, 1,2-propanediol, dipropyleneglycol, polypropyleneglycol, 1,3-propanediol, 1,4-butanediol, polytetramethyleneglycol, 1,5-pentanediol, 1,6-hexanediol and benzylic alcohols according to formula (II) 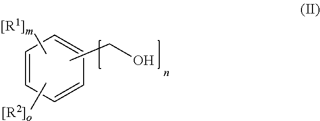
wherein
n is an integer from 1 to 4,
m is an integer from 0 to 3,
is 0 or 1,
$$m + n + o \leq 6 ,$$
R¹ and R² are independently of one another selected from the group consisting of F, Cl, Br, OH, CN, NH₂, NO₂,
C₁-C₁₀-alkyl,
C₃-C₁₀-cycloalkyl,
C₃-C₁₀-heterocyclyl comprising at least one heteroatom selected from N, O and S, C₅-C₁₄-aryl, and
C₅-C₁₀-heteroaryl comprising at least one heteroatom selected from N, O and S, wherein said C₁-C₁₀-alkyl, C₃-C₁₀-cycloalkyl, C₃-C₁₀-heterocyclyl, C₅-C₁₄-aryl, and C₅-C₁₀-heteroaryl, optionally has one or more further substituents selected from the group consisting of: F, Cl, Br, OH, CN, NH₂ and C₁-C₁₀-alkyl.

19. The process according to claim 16, wherein
(i) said base comprising an alkali metal cation is an alkali metal alkoxide of the formula MOR³ wherein M is selected from the group consisting of Li, Na and K
(ii) said alcohol is an alcohol of the formula R³OH
wherein R³ of (i) is identical to R³ of (ii).

20. The process according to claim 16, wherein step
(b) chemically converting γ-butyrolactone (I) by ring opening-polymerization to poly-4-hydroxybutyrate
is carried out at a temperature in the range of from −25° C. to +50° C.

21. The process according to claim 16, wherein in the reaction mixture prepared in step (a) the molar ratio of γ-butyrolactone (I) to the total amount of (i) bases comprising an alkali metal cation is in the range of from 200:1 to 800:1.

22. The process according to claim 16, wherein in the reaction mixture prepared in step (a) the molar ratio of the total amount of
(i) bases comprising an alkali metal cation
to the total amount of
(ii) alcohols
is in the range of from 1:1 to 10:1.

23. The process according to claim 16, wherein the reaction mixture prepared in step (a) further comprises one or more solvents.

24. The process according to claim 23, wherein the one or more solvents are selected from the group consisting of aliphatic hydrocarbons, aromatic hydrocarbons, ethers, esters, N,N-dialkylamides, dialkylsulfoxides and nitriles.

25. The process according to claim 16, wherein for preparing the reaction mixture in step (a)
a premix comprising (i) one or more bases comprising an alkali metal cation and (ii) one or more alcohols and one or more solvents
and/or
a mixture comprising (iii) γ-butyrolactone (I) and one or more solvents
is provided.

26. The process according to claim 25, wherein in each case the one or more solvents are selected from the group consisting of aliphatic hydrocarbons, aromatic hydrocarbons, ethers, esters, N,N-dialkylamides, dialkylsulfoxides and nitriles.

27. The process according to claim 16, further comprising drying of the γ-butyrolactone (I) by adding a drying agent, and optional separation of the dried γ-butyrolactone (I) from the drying agent before preparing the reaction mixture.

28. The process according to claim 27, wherein the drying agent is selected from the group consisting of CaH₂, tosyl isocyanate, and oxazolidines.

29. The process according to claim 28, wherein the oxazolidine is selected from the group consisting of oxazolidines of formula (III), oxazolidines of formula (IV), and oxazolidines of formula (V) 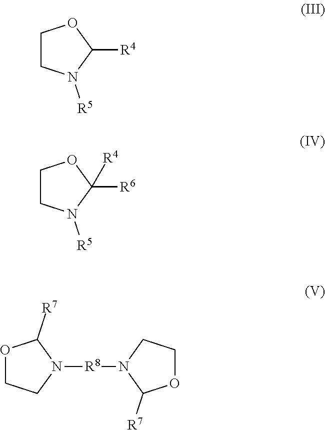
wherein R⁴, R⁵, R⁶, and R⁷ are independently of one another selected from the group consisting of H— and C₁-C₁₀-alkyl and R⁸ is a bridging unit comprising 1 to 20 —CH₂-units and optionally one or more moieties selected from the group consisting of

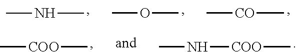

30. The process according to claim 16, wherein the γ-butyrolactone provided in step (a2) has a water content of 0.1 wt % or lower as measured by Karl-Fischer-titration.

31. The process according to claim 16, further comprising the step of
(c) quenching the ring-opening polymerization by adding a quenching solution comprising one or more acids and one or more solvents to the reaction mixture.

32. The process according to claim 31, wherein the one or more acids are selected from the group consisting of hydrohalogenic acids, oxo-acids of Cl, S, N, P and B, alkylsulfonic acids, arylsulfonic acids, mono-, di- and tri-functional carboxylic acids.

33. The process according to claim 16, said process comprising the steps of
(a) preparing a reaction mixture by
(a1) forming a premix comprising
(i) one or more bases selected from the group consisting of lithium tertbutoxide, sodium tertbutoxide, potassium tertbutoxide and potassium benzylalcoholate
and
(ii) one or more alcohols selected from the group consisting of methanol, ethanol, polyethyleneglycol, 1,4-butanediol, 1,6-hexanediol, benzylic alcohol, 1,4-benzenedimethanol, 2,6-dichlorobenzylalcohol, 4-methylbenzylalcohol and 2,4,6-trimethylbenzylalcohol,
(a2) providing γ-butyrolactone (I) having a temperature in the range of from −25° C. to −10° C. and a water content of 0.1 wt % or lower,
(a3) forming a reaction mixture by charging the premix formed in step (a1) into the γ-butyrolactone provided in step (a2),
wherein in the reaction mixture
the molar ratio of γ-butyrolactone to the total amount of bases (i) is in the range of from 200:1 to 400:1
and
the molar ratio of the total amount of bases (i) to the total amount of alcohols (ii) is in the range of from 1:1 to 1:8,
wherein the reaction mixture further comprises a solvent selected from the group consisting of dichloromethane, toluene, 2-methyl-tetrahydrofurane, 1,4-dioxane, glyme, diglyme, ethyl acetate, dimethylformamide, dimethylsulfoxide and acetonitrile and mixtures thereof,
(b) chemically converting the γ-butyrolactone in the reaction mixture by ring opening-polymerization to poly-4-hydroxybutyrate at a temperature in the range of from −25° C. to −10° C.,
(c) quenching the ring-opening polymerization by adding a quenching solution to the reaction mixture,
said quenching solution comprising an acid selected from the group consisting of hydrochloric acid, perchloric acid, nitric acid, sulfuric acid, phosphoric acid, boric acid, formic acid, acetic acid, acrylic acid, oxalic acid, propionic acid, lactic acid, citric acid, methanesulfonic acid and toluenesulfonic acid,
dissolved in a solvent selected from the group consisting of trichloromethane, deuterotrichloromethane, 1,2-dichlorethane, 1,1,2,2-terachlorethane, chlorobenzene, 1,4-dioxane, anisole, dimethylether, acetone, acetophenone, dihydrolevoglucosenon, dimethylcarbonate, diethylcarbonate, dimethylsulfoxide, acetonitrile and mixtures thereof,
said quenching solution having a temperature in the range of from −25° C. to 20° C.

34. The process according to claim 16, wherein a kit is used, the kit comprising:
(i) one or more bases comprising an alkaline metal cation, and
(ii) one or more alcohols.

35. A poly-4-hydroxybutyrate obtained by a process according to claim 16.
